(19) United States
(12) Patent Application Publication
(10) Pub. No.: US 2009/0089841 A1
(43) Pub. Date: Apr. 2, 2009

(54) SEAT-MOUNTED ELECTRONICS ASSEMBLY

(75) Inventors: SAMUEL R. HANLON, LIVONIA, MI (US); JOHN F. NATHAN, HIGHLAND TWP., MI (US); PATRICK MURRAY, BLOOMFIELD HILLS, MI (US); DOUG OLAH, NEW BOSTON, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: LEAR CORPORATION, SOUTHFIELD, MI (US)

(21) Appl. No.: 12/238,743

(22) Filed: Sep. 26, 2008

Related U.S. Application Data
(60) Provisional application No. 60/997,162, filed on Oct. 1, 2007.

(51) Int. Cl. H04N 7/18

(52) U.S. Cl. 725/75

(57) ABSTRACT

A seat-mounted electronics assembly for a vehicle including a seat with a back portion and a rear surface. A display panel having a screen mounted on a screen-side and a mounting assembly mounting the display panel on the rear surface. The mounting assembly allowing pivotal movement of the display panel relative to the seat between a stowed position and at least one viewing position so that when the display panel is in the viewing position, the display panel is located higher than when the display panel is in the stowed position and when the display panel is in the stowed position, the display panel is substantially parallel to the rear surface of the seat and the screen-side is oriented substantially in the forward direction. And when the display panel is in the viewing position, the screen-side is oriented substantially in the rearward direction.

### CROSS-REFERENCE TO RELATED APPLICATIONS

This application claims the benefit of U.S. Provisional Application No. 60/997,162, filed Oct. 1, 2007, the disclosure of which is incorporated herein by reference.

### BACKGROUND OF THE INVENTION

This invention relates in general to a vehicle entertainment system. More specifically, this invention relates to a seat-mounted entertainment assembly.

It is known in the art to provide a video display system in a vehicle. U.S. Pat. No. 7,084,932 teaches a display system including a digital video disk player and a screen rotatably mounted in a housing. U.S. Pat. No. 7,040,699 teaches a display screen mounted on a vehicle seat back by a support arm. US Patent Application 2005/0174498 teaches a display device mounted on a vehicle seat head rest, including a screen pivotally connected to a disk player.

### SUMMARY OF THE INVENTION

This invention relates to a seat-mounted electronics assembly for a vehicle including a seat with a back portion and a rear surface. A display panel having a screen mounted on a screen-side and a mounting assembly mounting the display panel on the rear surface. The mounting assembly allowing pivotal movement of the display panel relative to the seat between a stowed position and at least one viewing position so that when the display panel is in the viewing position, the display panel is located higher than when the display panel is in the stowed position and when the display panel is in the stowed position, the display panel is substantially parallel to the rear surface of the seat and the screen-side is oriented substantially in the forward direction. And when the display panel is in the viewing position, the screen-side is oriented substantially in the rearward direction.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a seat-mounted electronics assembly, with the view being taken from a position rearward of the seat.

FIG. 2 is a perspective view of the electronics assembly of FIG. 1 removed from the seat, with a display panel on the electronics assembly being illustrated in a viewing position.

FIG. 3 is a perspective view of the electronics assembly of FIG. 2, with the display panel in a stowed position.

FIG. 4 is a perspective view of the electronics assembly of FIG. 3, with the view being taken from a position forward of the electronics assembly.

FIG. 5 is an exploded, perspective view of the seat-mounted electronics assembly of FIG. 1.

FIG. 6 is a cross-sectional view of a clip assembly suitable for attaching the electronics assembly of FIG. 2 to the seat.

FIG. 7 is a schematic view of a base panel and display panel with a single hinge having a substantially horizontal axis of rotation.

FIG. 8 is a schematic view of a base panel and display panel with two hinges having substantially horizontal axes of rotation.

FIG. 9 is a schematic view of the base panel and display panel of FIG. 8, with the display panel in an alternative view position, with the view being taken from the side.

FIG. 10 is a schematic view of a base panel and display panel with one hinge having a substantially horizontal axis of rotation and a second hinge having a substantially vertical axis of rotation.

FIG. 11 is a schematic view of a base panel and display panel with a single hinge having a substantially vertical axis of rotation.

FIG. 12 is a schematic view of a vehicle entertainment system including two seat-mounted electronics assemblies connected to share signals.

### DETAILED DESCRIPTION OF THE PREFERRED EMBODIMENT

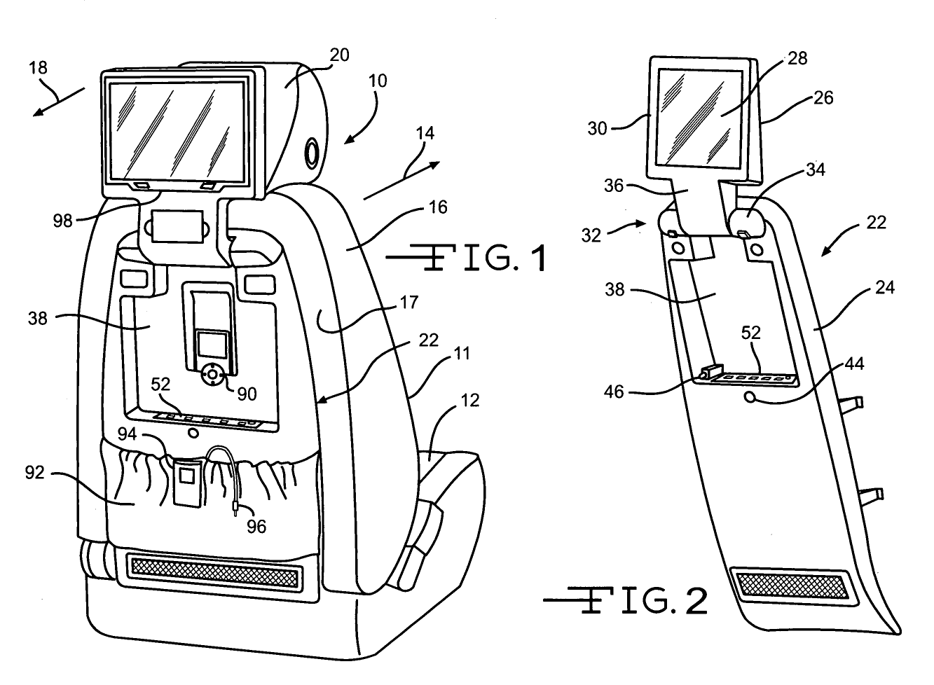

Referring now to the drawings, there is illustrated in FIG. 1 a seat-mounted electronics assembly 10. The seat-mounted electronics assembly 10 includes a vehicle seat 11. The vehicle seat 11 is suitable for use in an automobile, mini-van, or other sort of vehicle. The vehicle seat 11 includes a lower portion 12, configured primarily to support a person's buttocks and thighs. The vehicle seat 11 includes a back portion 16, configured primarily to support a person's back and torso. An occupant of the seat 11 faces in a forward direction, indicated by the arrow 14. The back portion 16 includes a rear surface 17 which faces in a rearward direction, indicated by the arrow 18. It should be understood that the terms “forward” and “rearward” refer to directions relative to the vehicle seat 11. These directions usually correspond to the way in which the seat would normally be mounted in a vehicle. However, it should be understood that the vehicle seat 11 could be mounted for rotational movement within a vehicle, and the terms “forward” and “rearward” remain in reference to the vehicle seat 11. The vehicle seat 11 includes an optional head restraint 20. The head restraint 20 is mounted to the upper portion of the back portion 16. The seat-mounted electronics assembly 10 also includes an electronics assembly, shown generally at 22. The electronics assembly 22 is attached to the rear surface 17 of the back portion 16.

Referring to FIG. 2, the electronics assembly 22 is illustrated removed from the vehicle seat 11. The electronics assembly 22 includes a base panel 24. The illustrated base panel 24 is a plastic component, configured to fit on the rear surface 17 of the back portion 16 of the vehicle seat 11. The base panel 24 can be made of other materials, and can be custom-designed for a particular vehicle seat 11, or can be a generic shape, designed to fit a variety of vehicle seats.

The electronics assembly 22 also includes a display panel 26. The illustrated display panel 26 has two major surfaces, a screen-side 30 and a back0side 40 (shown in FIG. 3). A video screen 28 mounted on screen-side 30. The illustrated display panel 26 is a plastic component that provides structural support and rigidity for the video screen 28. The illustrated video screen 28 is a flat-screened liquid crystal display. Other types of screens can be used for the video screen 28, including organic light emitting diodes. The video screen 28 could also be a touch-sensitive screen. This would allow a user to interact with the electronics assembly 22 through the video screen 28.

The electronics assembly 22 includes a mounting assembly, indicated generally at 32, that mounts the display panel 26 on the base panel 24. The illustrated mounting assembly 32 is located near an upper end of the base panel 24 and is connected to an edge of the display panel 26. Mounting assembly 32 allows the display panel 26 to move pivotally relative to the base panel 24. The illustrated mounting assembly 32 consists of a hinge 34. The illustrated hinge 34 is a bi-directional torque hinge, and has a substantially horizontal axis of rotation. This allows a user to easily adjust the position of the display panel 26 to a desired viewing position. It should be appreciated that other types of hinges can be used for the mounting assembly 32, as well as hinges having an axis of rotation other than substantially horizontal.

With the screen-side 30 facing substantially in the rearward direction 18, the video screen 28 can be viewed by the user. The torque hinge 34 resists movement of the display panel 26, and will maintain the display panel 26 in the selected viewing position. When the illustrated display panel 26 is rotated from the stowed position to a viewing position on the hinge 34, it is moved upwards. That is, the display panel 26 is located higher when it is in a viewing position than when it is in the stowed position. This provides the advantage of placing the video screen 28 higher in the user's field of view. By allowing the user to look upwards rather than downwards when viewing the video screen 28, the user is potentially less likely to suffer from motion sickness. Additionally, by providing a display panel that is attached to the back portion 16 of the vehicle seat 11, a larger video screen 28 can be provided than if a video screen were attached to the back of the head restraint 20.

The illustrated mounting assembly 32 also includes an optional extension tab 36. The extension tab 36 is located between the hinge 34 and the display panel 26, and provides a connection between the hinge 34 and the display panel 26. The extension tab 36 provides spacing between the hinge 34 and the display panel 26. The illustrated extension tab 36 is molded as part of the display panel 26. This is not necessary, and the extension tab 36 could be otherwise attached to the display panel 26. Alternatively, the electronics assembly 22 could be provided without the extension tab, since it is an optional component.

The base panel 24 further defines a recess 38. In the embodiment shown, the recess 38 is situated below the mounting assembly 32. As shown in FIG. 3, the mounting assembly 32 allows the display panel 26 to pivot down into the stowed position with the display panel located within the recess 38. When the display panel 26 is in this stowed position, the display panel 26 is substantially parallel with the base panel 24, and the screen-side 30 is oriented in the forward direction 14. That is, the video screen 28 is located between the base panel 24 and the display panel 26. This provides protection to the video screen 28. When the display panel 26 is in the stowed position, the back-side 40 of the display panel 26 is oriented in the rearward direction 18, and is the primary exposed portion of the display panel 26. The illustrated backside 40 includes an optional decorative panel 42. The decorative panel 42 can be any sort of decorative color or texture such as faux wood or fabric. Alternatively, the back-side 40 could be provided without the decorative panel 42, since it is an optional component. The back-side 40 could also include an additional video screen.

In the illustrated electronics assembly 22, when the display panel 26 is in the stowed position, the display panel 26 is located fully within the recess 38 and is substantially flush with the base panel 24. That is, the back-side 40 provides consistent contours with the surface of the base panel 24. Having the stowed display panel 26 substantially flush with the base panel 24 provides a particular aesthetically pleasing appearance to the electronics assembly 22. Also, since the edges of the display panel 26 are located within the recess 38, items adjacent to the electronics assembly 22 are less likely to get caught on the display panel 26. It should be appreciated that these goals can be accomplished without the display panel 26 being located completely within the recess 38. For instance, the display panel 26 can have rounded edges that substantially conform to the contours base panel 24 and thus be substantially flush with the base panel 24.

The base panel 24 includes a latch assembly 44 located near the lower edge of the recess 38. The latch assembly is configured to cooperate with the edge of the display panel 26 in order to hold the display panel 26 in place when it is placed in the stowed position. In the illustrated embodiment, when the latch assembly 44 is engaged, the display panel 26 is locked in the stowed position and is not able to move. When the latch assembly 44 is released, the display panel 26 is free to rotate about the hinge 34. The illustrated latch assembly 44 is a physical clasp. It should be appreciated that some other sort of latch assembly can be used, such as a magnetic clasp. Further, it should be appreciated that the latch assembly 44 can be located in a position other than that illustrated. For instance, the latch assembly 44 can be located at some other part of the recess 38, or a latch assembly 44 can be located on the mounting assembly 32, directly on the hinge 34, for instance. Additionally, it should be appreciated that the latch assembly 44 is an optional component, and could not be included.

Best seen in FIG. 2, the illustrated base panel also includes a biasing assembly 46. The illustrated biasing assembly 46 is a pair of bumpers (only one of which is visible in FIG. 2). The biasing assembly 46 is in the lower portion of the recess 38. The biasing assembly 46 is disposed to be between the base panel 24 and the display panel 26 when the display panel is in the stowed position. When the display panel is in the stowed position, the biasing assembly 46 provides a force in the rearward direction 18 on the display panel 26. The biasing assembly 46 is provided to prevent rattling of the display panel 26 while in the stowed position. In the illustrated embodiment, the force that the biasing assembly 46 places on the display panel 26 is great enough to overcome the resistance to pivoting of the torque hinge 34. As such, when the latch assembly 44 is released, the display panel 26 will be pushed out of the stowed position by the biasing assembly 46. This allows the user to more easily grasp the display panel 26 in order to rotate it into a desired viewing position. This initial displacement of the display panel 26 from the stowed position is particularly useful if the display panel 26 is located completely within the recess 38, since the user might otherwise be unable to grip the display panel 26. The illustrated biasing assembly 46 is a pair of hollow-head rubber bumpers. The rubber bumpers are compressed by the display panel 26 when it is in the stowed position. It should be appreciated that some other type or configuration of biasing assembly 46 can be used with the electronics assembly 22. For instance, a single rubber bumper could be used across the bottom of the recess 38, or a biasing spring could be included at the hinge 34. Alternatively, the electronics assembly 22 could be provided without any biasing assembly 46, as this is an optional component.

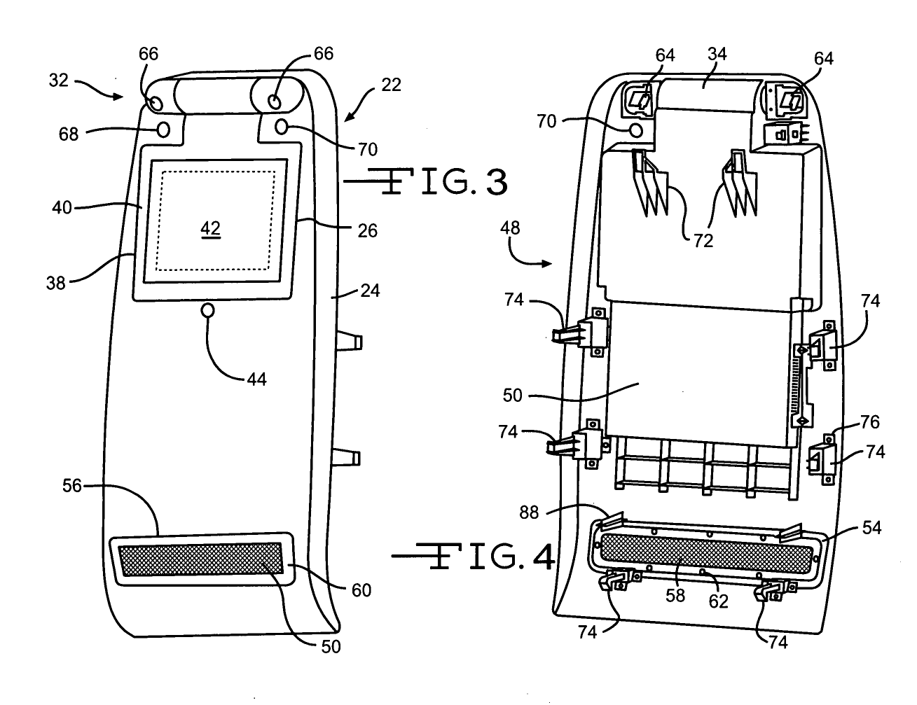

Referring now to FIG. 4, a forward-facing side, indicated generally at 48, of the base panel 24 is shown. It should be appreciated that the forward-facing side 48 side of the base panel 24 is not normally visible when the electronics assembly 22 is installed on a vehicle seat 11, since the forward-facing side 48 will be buried or concealed between the vehicle seat 11 and the base panel 24. Mounted on the forward-facing side 48 is a video playback module 50. The video playback module 50 is operatively connected to the video screen 28. The illustrated video playback module 50 is a digital versatile disk (DVD) player. It should be appreciated that the video playback module 50 can be any sort of video playback device, such as a video cassette player, a video disk player, a Blu-Ray Disc® player or an mp4 player. Alternatively, the video playback module 50 could be a device that plays only audio format media. The illustrated video playback module 50 is mounted just below the recess 38, although it can be mounted in other locations.

The video playback module 50 includes controls 52. Referring back to FIG. 2, the controls 52 for the video playback module 50 are disposed within the recess 38. This allows the user to access the controls 52 when the display panel 26 is in a viewing position. The controls 52 will be protected and concealed by the display panel 26 when the display panel 26 is in the stowed position, as shown in FIG. 3. The illustrated controls 52 include the controls on the face of the DVD player as well as the media slot for the slot-load DVD player. The controls 52 can be illuminated in order to allow the user to easily use the controls 52 in low-light situations. The controls 52 can include additional input and output devices, such as an SD card slot, RCA inputs and outputs, USB ports, or headphone jacks. The controls 52 could also include a power port, to allow the user to power external devices. The controls 52 allow the user to operate the video playback module 50, as well as to operate other features through the electronics assembly 22. For instance, the controls 52 may allow the user to select between multiple video signals for display on the video screen 28. Available video signals could include the signal from the video playback module 50, the signal from another video playback module on another vehicle seat video playback module located in the vehicle, the signal from a central DVD player in the vehicle, the signal from an antenna, the signal from a vehicle GPS, the signal from a vehicle back-up camera, as well as other signals. Additionally, controls 52 may allow the user to operate other vehicle components, such as individual climate control options. It should be appreciated that the controls 52 could be located somewhere other than where illustrated.

Referring to FIGS. 3 and 4, an optional ventilation opening 54 is visible at the lower portion of the base panel 24. The illustrated ventilation opening 54 is generally rectangular in shape, and the opening is concealed by a vent cover 56. The vent cover 56 includes a mesh screen 58 held in a bezel 60, which is held in place by heat stake posts 62. The ventilation opening 54 provides fluid communication between the forward and rearward sides of the base panel 24. The ventilation opening allows a ventilation system (not shown) of the vehicle seat 11 to communicate with the passenger compartment. The ventilation opening also provides ventilation for the video playback module 50. It should be appreciated that ventilation opening 54 can be located other than where illustrated, and could consist of a different number or configuration of openings. For instance, ventilation could be provided through a larger number of small, unscreened openings along one or more edges of electronics assembly 22.

Two optional LED lights 64 are mounted near the upper portion of the base panel 24. The illustrated lights 64 are mounted on either side of the hinge 34. Referring to FIG. 3, the lenses 66 for the lights 64 are visible. The lights 64 are positioned to provide illumination for the convenience of the user for operating the controls 52, selecting media to insert into the video playback module 50, using other input devices, or even reading. A switch 68 is mounted below one of the lights 64. The switch 68 is operatively connected to the lights 64. In the illustrated embodiment, the single switch 68 activates and deactivates both lights 64 in unison. It should be appreciated that the switch 68 could be wired so that lights 64 can be turned on or off individually. Alternatively or additionally, lights 64 can be operatively connected to activate when the vehicle dome light, not shown, is turned on. Further, it should be appreciated that the lights 64 are not necessary on the electronics assembly 22. There could be more or fewer lights, or no lights at all. The illustrated base panel 24 includes two switch openings 70. The switch 68 can be mounted on or within either of these switch openings 70. The other switch opening 70 would normally be covered with a decorative plug.

One system for attaching the electronics assembly 22 to the vehicle seat 11 will now be described. As shown in FIG. 4, the forward-facing side 48 of the electronics assembly 22 includes a pair of hangers 72 located near the upper portion of the base panel 24. The illustrated hangers 72 are formed as part of the base panel 24, although they could be made separately and attached to the base panel 24. The forward-facing side 48 also includes resilient clip assemblies 74 located near the lower portion of the base panel 24. The illustrated clip assemblies 74 are attached to the base panel 24 by vibration welded pins 76. It should be appreciated that the hangers 72 and the clip assemblies 74 can be attached to the base panel 24 by other suitable methods.

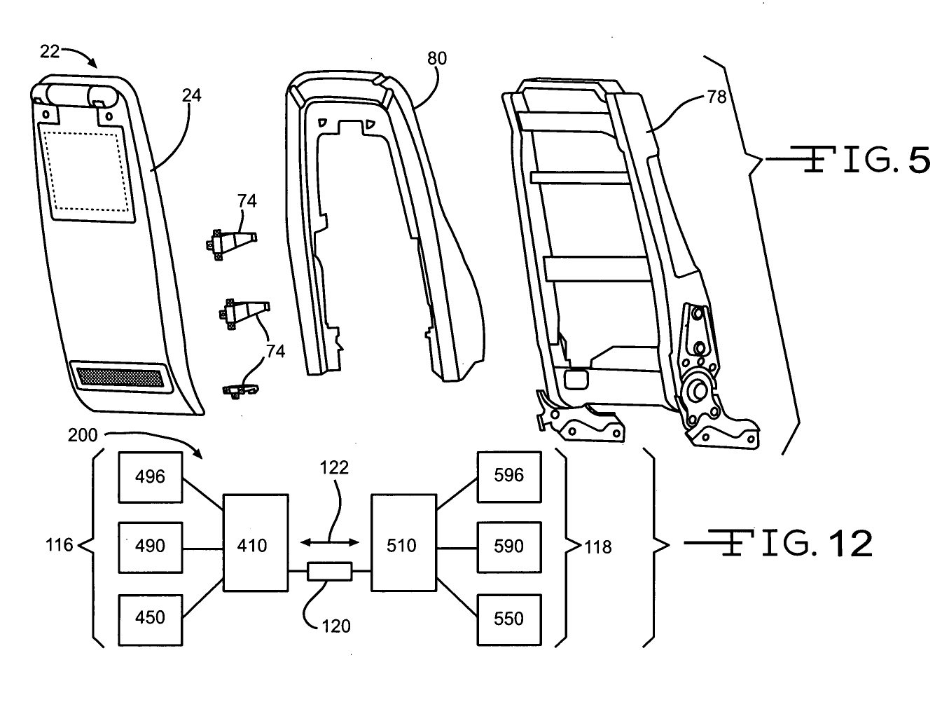

Referring to FIG. 5, an exploded view of the illustrated assembly for attachment of the electronics assembly 22 to the vehicle seat 11 is shown. The illustrated vehicle seat 11 includes a steel seat back frame 78. An optional frame panel 80 is attached to the seat back frame 78 using any suitable method. The illustrated frame panel 80 is a plastic component that provides a uniform surface for the attachment of the base panel 24. The frame panel 80 also provides a uniform surface over which foam and trim can be placed. This provides for a clean, finished appearance of the vehicle seat 11 and electronics assembly 22. The hangers 72 (not visible in FIG. 5) attach to the seat back frame 78 and the clip assemblies 74 engage the frame panel 80.

Shown in cross-section in FIG. 6, clip assembly 74 includes a resilient arm 82. The resilient arm 82 defines a sloped deflection surface 84. During connection of the base panel 24 to the frame panel 80, deflection surface 84 contacts the frame panel 80, and resilient arm 82 is deflected. This allows the clip assembly to move past the frame panel 78. Once the clip assembly 74 has moved past the frame panel 80, the clip assembly straightens to its initial position, and the locking surface 86 prevents the clip assembly 74 from being removed from the frame panel 80. Although one assembly for attaching the electronics assembly 22 to the vehicle seat 11 has been shown, it should be appreciated that other assemblies for attachment can be used. Further, it should be appreciated that if the electronics assembly 22 includes heavier components, such as a large video screen 28 or a large video playback module 50, it may be necessary to strengthen the attachment of the electronics assembly 22 to the vehicle seat 11. The attachment can be strengthened by using more, larger or more robust clip assemblies, or by bolting the base panel 24 to the seat back frame 78, for example.

Referring back to FIG. 4, the forward-facing side 48 also includes optional standoff posts 88. The standoff posts 88 are configured to engage the seat back frame 78 and stabilize the base panel 24. Standoff posts 88 are an optional component, and do not have to be included.

Although one assembly for attaching the electronics assembly 22 to the vehicle seat 11 has been described, it should be appreciated that any suitable method of attachment can be used.

Referring back to FIG. 1, additional, optional features of the electronics assembly 22 are shown. These include a media player docking station 90. Media player docking station 90 is operative to connect an external media player to the controls 52, allowing the user to watch and listen to media stored on an external device through the outputs of the electronics assembly 22. Also shown are a map pocket 92 and a media player pocket 94. Illustrated media player pocket 94 is sewn into the map pocket 92, and is provided to hold a media player in a position in which the user has access to the face of the device. An input line 96 is provided for attachment to the output of an external media player. Input line 96 is operatively connected to the controls 52, allowing the user to watch and listen to media stored on an external device through the outputs of the electronics assembly 22. Input line 96 is situated so that, when not in use, it can be located within the map pocket 92. An infrared sensor 98 is shown on the display panel 26 just beneath the video screen 28. Infrared sensor 98 allows an external device to communicate wirelessly with the electronics assembly 22. This allows a remote control to be used to operate the video playback module 50, for instance. Although illustrated on the display panel 26 just beneath the video screen 28, it should be appreciated that the infrared sensor 98 may be disposed at a different location, or may not be included on the electronics assembly 22, since it is an optional component. It should also be appreciated that some other format of wireless communication can be used in place of infrared. For instance, a radio frequency receiver could be used.

The illustrated electronics assembly 22 is configured to allow the user to play back media from a variety of sources, and watch and listen to that playback. In order to listen to audio playback, the electronics assembly 22 includes a wireless Bluetooth® system (not shown) which can be listened to using compatible headphones. The electronics assembly could alternatively or additionally include integral speakers, or output ports to allow for the connection of speakers or headphones.

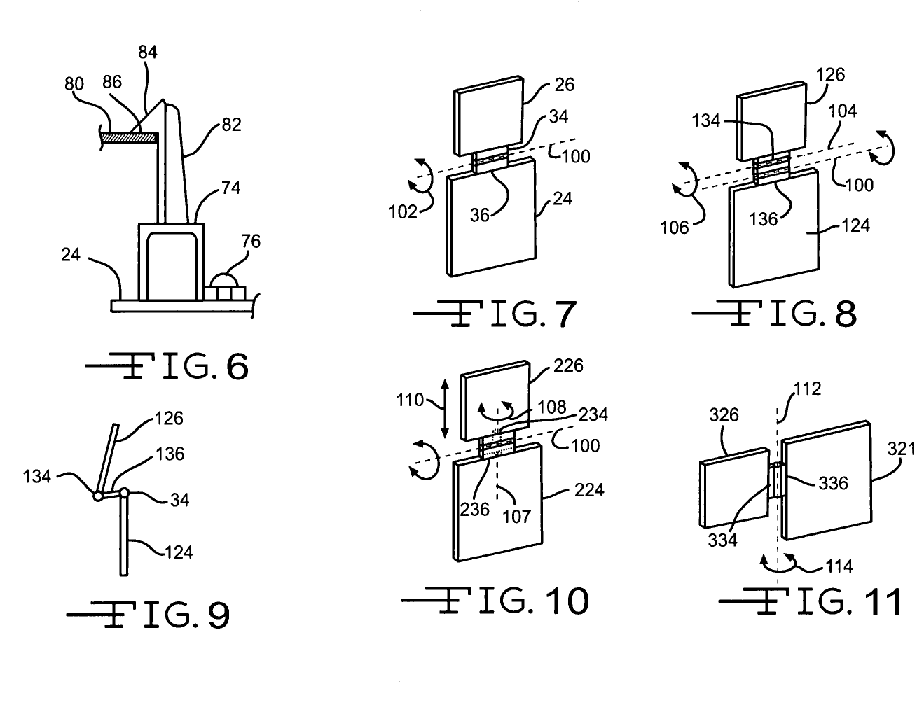

Referring to FIG. 7, there is schematically shown the base panel 24 and display panel 26. As previously discussed, display panel 26 is able to be moved pivotally relative to the base panel 24. The display panel is able to rotate about hinge 34 having a substantially horizontal axis 100, as indicated by arrow 102. It should be appreciated that the display panel could be provided with additional movement capabilities. For instance, referring to FIG. 8, a second hinge 134 having a substantially horizontal axis of rotation 104 could be provided, allowing a display panel 126 to rotate relative to a base panel 124 as shown by the arrow 106. This second axis of rotation 104 could, for example, be provided between an extension tab 136 and the display panel 126. This would allow a user more options in the adjustment of the display panel 126, such as shown schematically in FIG. 9.

Alternatively, referring to FIG. 10, a display panel 226 could be provided with the display panel being able to rotate about a hinge 234 having a substantially vertical axis 107, as indicated by arrow 108. This would enable the user, for instance, to make the display panel 226 visible to another occupant of the vehicle. Further, the display panel 226 could be configured for sliding movement relative to the base panel 224, as indicated by the arrow 110. This could be accomplished, for example, by providing an extension tab 236 that is telescoping, or includes sliding, keyed pieces (conceptually similar to a slide rule). Additionally, referring to FIG. 11, it should be appreciated that a display panel 326 can be configured to rotate relative to a base panel 324 on a hinge 334 having a substantially vertical axis 112, as indicated by arrow 114.

The illustrated embodiments of the vehicle seat 11 with an electronics assembly 22 include a frame panel 80, shown in FIG. 5. It should be appreciated that an electronics assembly 22 and frame panel 80 could be unique to the seat in a particular make and model of vehicle. However, it should also be appreciated that a single design of electronics assembly 22 could fit the seats in a variety of makes and models of vehicles, by using different frame panels 80. It should also be appreciated that the frame panel 80 is a useful component for the installation of the electronics assembly 22, but is it not required.

The illustrated embodiments of the vehicle seat 11 with an electronics assembly 22 include a base panel 24. The base panel is a useful component, but is optional. It should be appreciated that the mounting assembly 32 can be mounted directly on the vehicle seat 11. The mounting assembly 32 could be mounted to the seat 10 by any suitable means.

The illustrated embodiments of the vehicle seat-mounted electronics assembly 10 are shown and described above as a single assembly in a vehicle. It should be appreciated that multiple seat-mounted electronics assemblies can be located within a single vehicle. Referring to FIG. 12, there is shown schematically a vehicle entertainment system, indicated generally at 200. The vehicle entertainment system 200 includes a first seat-mounted electronics assembly 410 and a second seat-mounted electronics assembly 510. The illustrated first and second seat-mounted electronics assemblies may be mounted on separate seats within the same vehicle. For instance, the first seat-mounted electronics assembly is mounted on the driver's seat, while the second seat-mounted electronics assembly is mounted on the front passenger's seat. It should be appreciated that an additional number of seat-mounted electronics assemblies could be included in a single vehicle, and could be mounted in locations other than directly on a seat.

The illustrated first seat-mounted electronics assembly 410 is configured to receive signals from a variety of first sources, indicated at 116. First sources 116 can include sources such as a first video playback module 450, a first media player docking station 490 or a first input line 496. The illustrated second seat-mounted electronics assembly 510 is configured to receive signals from a variety of second sources, indicated at 118. Second sources 118 can include sources such as a second video playback module 550, a second media player docking station 590 or a second input line 596. The first and second sources 116 and 118 can provide audio and video signals for playback on the respective seat-mounted electronics assembly.

The entertainment system 200 also includes a communications connection 120. Communications connection 120 provides an electronic connection between the first seat-mounted electronics assembly 410 and the second seat-mounted electronics assembly 510. The first seat-mounted electronics assembly 410 and the second seat-mounted electronics assembly 510 are configured to exchange communication signals, indicated by arrow 122, across the communications connection 120. Communications connection 120 can be a wired or wireless connection. The exchange of communication signals 122 allows the first seat-mounted electronics assembly 410 and the second seat-mounted electronics assembly 510 to share first sources 116 and second sources 118. Sharing the sources 116 and 118 may mean, for example, that a user of the first seat-mounted electronics assembly 410 is able to select signals from any of the first sources 116 or the second sources 118 for playback on the first seat-mounted electronics assembly 410.

Sharing the sources 116 and 118 may further allow a user of the first seat-mounted electronics assembly 410 to control one or more second sources 118 through controls (not shown) on the first seat-mounted electronics assembly 410. For instance, a passenger seated behind the driver's seat could control the playback of a DVD loaded into a player situated behind the passenger's seat using controls mounted on the back of the driver's seat. Alternatively, the communication signals 122 may not allow the first seat-mounted electronics assembly 410 to control the second sources 118. Instead, communication signals 118 may only allow first seat-mounted electronics assembly 410 to receive second sources 118. Alternatively, the communication signals 122 may allow the first seat-mounted electronics assembly 410 to control second sources 118 only when the second seat-mounted electronics assembly 510 either allows that control, or does not prevent that control.

It should be appreciated that the options of control and playback described as being available to the first seat-mounted electronics assembly 410 would also be available to the second seat-mounted electronics assembly 510.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A seat-mounted electronics assembly for a vehicle, the assembly comprising:
a seat including a back portion having a rear surface facing a rearward direction;
a display panel having a screen-side and a back-side, with a video screen mounted on the screen-side of the display panel; and
a mounting assembly configured to mount the display panel on the rear surface of the seat, the mounting assembly configured to allow pivotal movement of the display panel relative to the seat between a stowed position and at least one viewing position, the mounting assembly located at an upper portion of the display panel and configured so that when the display panel is in the viewing position, the display panel is located at a higher position than when the display panel is in the stowed position;
wherein the mounting assembly is configured so that when the display panel is in the stowed position, the display panel is substantially parallel to the rear surface of the seat, and the screen-side is oriented substantially in the forward direction, and wherein when the display panel is in the viewing position, the screen-side is oriented substantially in the rearward direction.

2. The seat-mounted electronics assembly of claim 1, further comprising a base panel covering a portion of the rear surface of the seat, wherein the mounting assembly is mounted on the base panel.

3. The seat-mounted electronics assembly of claim 2, further comprising a video playback module mounted on the base panel.

4. (canceled)

5. The seat-mounted electronics assembly of claim 2, wherein the mounting assembly includes a hinge that pivots on a substantially horizontal axis.

6. The seat-mounted electronics assembly of claim 5, wherein the mounting assembly includes an extension tab that is connected to the display panel such that the display panel is spaced from the hinge.

7. The seat-mounted electronics assembly of claim 6, wherein the extension tab is rigidly connected to the display panel.

8. The seat-mounted electronics assembly of claim 6, wherein the extension tab is connected to the display panel by a second hinge that pivots on a second substantially horizontal axis.

9. (canceled)

10. The seat-mounted electronics assembly of claim 2, wherein the mounting assembly includes a first hinge that pivots on a substantially horizontal axis and a second hinge that pivots on a second substantially horizontal axis.

11. The seat-mounted electronics assembly of claim 2, wherein the base panel defines a recess configured to receive the display panel when the display panel is in the stowed position.

12. The seat-mounted electronics assembly of claim 11, wherein the recess, display panel and mounting assembly are configured so that the display panel is substantially flush with the base panel when the display panel is in the stowed position.

13. The seat-mounted electronics assembly of claim 12, further including a latch, the latch releasably retaining the display panel in the stowed position, and further including a biasing assembly, the biasing assembly configured to move the display panel from the stowed position when the latch is released.

14. (canceled)

15. The seat-mounted electronics assembly of claim 1, further including auxiliary inputs configured to allow electronic connection of a media playback device to the seat-mounted electronics assembly.

16. A seat-mounted electronics assembly for a vehicle, the assembly comprising:
a seat including a back portion having a rear surface facing a rearward direction;
a display panel having a screen-side and a back-side, with a video screen mounted on the screen-side of the display panel; and
a mounting assembly configured to mount the display panel on the rear surface of the seat, the mounting assembly configured to allow pivotal movement of the display panel relative to the seat between a stowed position and at least one viewing position, the mounting assembly configured so that the display panel can pivot about a hinge with a substantially vertical axis;
wherein the mounting assembly is configured so that when the display panel is in the stowed position, the display panel is substantially parallel to the rear surface of the seat, and the screen-side is oriented substantially in the forward direction, and wherein when the display panel is in the viewing position, the screen-side is oriented substantially in the rearward direction.

17. The seat-mounted electronics assembly of claim 16, further comprising a base panel covering a portion of the rear surface of the seat, wherein the mounting assembly is mounted on the base panel and wherein the base panel defines a recess configured to receive the display panel when the display panel is in the stowed position, wherein the recess, display panel and mounting assembly are configured so that the display panel is substantially flush with the base panel when the display panel is in the stowed position.

18. (canceled)

19. (canceled)

20. A vehicle entertainment system comprising:
a first seat-mounted electronics assembly including a first seat with a first back portion having a first rear surface facing a rearward direction, a first display panel having a first video screen mounted on the first screen-side thereof, a first mounting assembly configured to mount the first display panel on the first rear surface of the first seat;
a first source operatively connected to the first seat-mounted electronics assembly wherein the first source provides first signals to the first seat-mounted electronics assembly;
a second seat-mounted electronics assembly including a second seat with a second back portion having a second rear surface facing a rearward direction, a second display panel having a second video screen mounted on the second screen-side thereof, a second mounting assembly configured to mount the second display panel on the second rear surface of the second seat;
a second source operatively connected to the second seat-mounted electronics assembly wherein the second source provides second signals to the second seat-mounted electronics assembly; and
a communications connection, configured allow the first seat-mounted electronics assembly to share the second source.

21. The seat-mounted electronics assembly of claim 11, further comprising a video playback module mounted on the base panel, wherein the video playback module includes controls disposed such that the controls are located in the recess and are covered by the display panel when the display panel is in the stowed position.

22. The seat-mounted electronics assembly of claim 21, wherein the video playback module is located below the recess.

23. The seat-mounted electronics assembly of claim 1, further comprising a switch mounted on the base panel and a light mounted on the base panel, wherein the light is operated by the switch.

24. The seat-mounted electronics assembly of claim 1, wherein the seat further includes a head restraint mounted at an upper portion of the back portion, wherein the head restraint is separate from the back portion.

25. The seat-mounted electronics assembly of claim 1, wherein the seat is a first seat, the display panel is a first display panel and the mounting assembly is a first mounting assembly;
a first source providing first signals, the first source operatively connected to the first display panel, the first display panel configured to display the first signals;
a second seat including a second back portion having a second rear surface facing a rearward direction, a second display panel having a screen-side and a back-side, with a video screen mounted on the screen-side of the display panel, a second mounting assembly configured to mount the second display panel on the rear surface of the second seat;
a second source providing second signals, the second source operatively connected to the second display panel, the second display panel configured to display the second signals;
a communications connection, configured allow the first display panel to share the second source.
